(19) United States
(12) Patent Application Publication
(10) Pub. No.: US 2016/0085493 A1
(43) Pub. Date: Mar. 24, 2016

(54) IMAGE FORMING APPARATUS HAVING RESERVATION PRINTING FUNCTION, CONTROL METHOD FOR THE IMAGE FORMING APPARATUS, AND STORAGE MEDIUM

(71) Applicant: CANON KABUSHIKI KAISHA, Tokyo (JP)

(72) Inventor: Takayuki Kaneko, Moriya-shi (JP)

(21) Appl. No.: 14/854,314

(22) Filed: Sep. 15, 2015

(30) Foreign Application Priority Data
Sep. 19, 2014 (JP) 2014-191491

(51) Int. Cl. G06F 3/12

(52) U.S. Cl. CPC G06F 3/1274; G06F 3/1238; G06F 3/1222

(57) ABSTRACT

An image forming apparatus which enables all group users who share a print job to order execution of the print job. It is determined whether or not execution of a stored print job is ordered by a plurality of users. When it is determined that execution of the print job is ordered by a plurality of users, the print job is not deleted even after it is executed.

### BACKGROUND OF THE INVENTION

1. Field of the Invention

The present invention relates to an image forming apparatus, a control method for the image forming apparatus, and a storage medium.

2. Description of the Related Art

In general, there may be cases where a user sends a print job from external equipment such as a PC, which is connected to an image forming apparatus. The image forming apparatus has a reservation printing function of, upon receiving a print job, storing the received print job in a storage device which the image forming apparatus has, and when a user operates an operating unit, which the image forming apparatus has, so as to execute the print job, executing the print job stored in the storage device.

There are private users and group users as users who send print jobs to the image forming apparatus. A private user does not share a print job with any other users, and a group user shares a print job with at least one other user (hereafter referred to as “the other group users”).

There are known image forming apparatuses which delete a print job from a storage device when a group user orders execution of a print job stored in the storage device, and all the other group users accessed the print job stored in the storage device, or when none of the other group users has accessed the print job stored in the storage device until lapse of a predetermined time period (see, for example, Japanese Laid-Open Patent Publication (Kokai) No. H07-177277).

There are also known image forming apparatuses with the reservation printing function which has a deleting function of, immediately after executing a print job, deleting the print job from a storage device in which the print job has been stored (see, for example, Japanese Laid-Open Patent Publication (Kokai) No. 2014-148064).

There may be cases where a group user instructs an image forming apparatus with the deleting function to execute a print job stored in a storage device.

In such cases, a problem will arise because when the print job of which execution has been ordered by the group user is executed, the print job is deleted from the storage device by the deleting function which the image forming apparatus has, and the other group users who share the print job cannot order execution of the print job.

### SUMMARY OF THE INVENTION

The present invention provides an image forming apparatus and a control method therefor which enable all group users who share a print job to order execution of the print job, as well as a storage medium.

Accordingly, the present invention provides an image forming apparatus for which execution of a stored print job is ordered by a user, comprising a deleting unit configured to delete the print job after the print job is executed, a determination unit configured to determine whether execution of the print job is ordered by a plurality of users, and a decision unit configured to decide whether to enable or disable said deleting unit based on a determination result by said determination unit.

According to the present invention, based on whether a print job of which execution will be ordered by a plurality of users, whether to enable or disable the deleting function for the print job is decided. As a result, all group users who share a print job are allowed to order execution of the print job.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of an image forming system including an image forming apparatus according to an embodiment of the present invention.

FIG. 2 is a block diagram schematically showing an internal arrangement of the image forming apparatus in FIG. 1.

FIG. 3 is a block diagram schematically showing an internal arrangement of system software of the image forming apparatus, which is executed by a CPU of the image forming apparatus in FIG. 2.

FIGS. 4A to 4C are views useful in explaining user authentication which is performed by a user authentication unit in FIG. 3.

FIG. 5 is a block diagram schematically showing an internal arrangement of a PC in FIG. 1.

FIG. 6 is a block diagram schematically showing an arrangement of system software of the PC, which is executed by a CPU of the PC in FIG. 5.

FIG. 7 is a flowchart showing the procedure of a job sending process which is carried out by a printer driver in FIG. 6.

FIG. 8 is a view useful in explaining a print screen which is displayed on a display device in step S701 in FIG. 7.

FIG. 9 is a flowchart showing the procedure of a storage process in which a PDL job sent to the image forming apparatus in step S704 in FIG. 7 is stored in the image forming apparatus.

FIG. 10 is a view useful in explaining an information list showing information on a PDL job stored in the storage device in step S903 in FIG. 9.

FIG. 11 is a flowchart showing the procedure of a display process in which a job list generated based on the information list in FIG. 10 is displayed on an operating unit.

FIG. 12 is a view useful in explaining a print job list which is displayed on the operating unit in step S1105 in FIG. 11.

FIG. 13 is a flowchart showing the procedure of a deleting process in which a PDL job selected in a display area in FIG. 12 is deleted after being executed.

FIG. 14 is a flowchart showing a first variation of the deleting process in FIG. 13.

FIG. 15 is a view useful in explaining a mode setting screen on which a deleting mode is selected for the image forming apparatus in FIG. 2.

FIG. 16 is a flowchart showing a second variation of the deleting process in FIG. 13.

FIG. 17 is a view useful in explaining a receiving screen which is displayed on the operating unit in step S1601 in FIG. 16.

FIG. 18 is a flowchart showing a third variation of the deleting process in FIG. 13.

FIGS. 19A and 19B are views useful in explaining a private document job list or a group document job list displayed in step S1802 in FIG. 18.

### DESCRIPTION OF THE EMBODIMENTS

The present invention will now be described in detail with reference to the drawings showing an embodiment thereof.

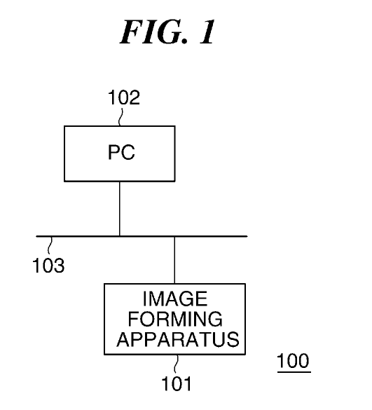

FIG. 1 is a block diagram schematically showing an arrangement of an image forming system 100 including an image forming apparatus 101 according to an embodiment of the present invention.

The image forming system 100 in FIG. 1 has the image forming apparatus 101 and a PC 102, and the image forming apparatus 101 and the PC 102 are connected together via a LAN 103. A print job including print data is sent from the PC 102 to the image forming apparatus 101, and the image forming apparatus 101 receives the print job.

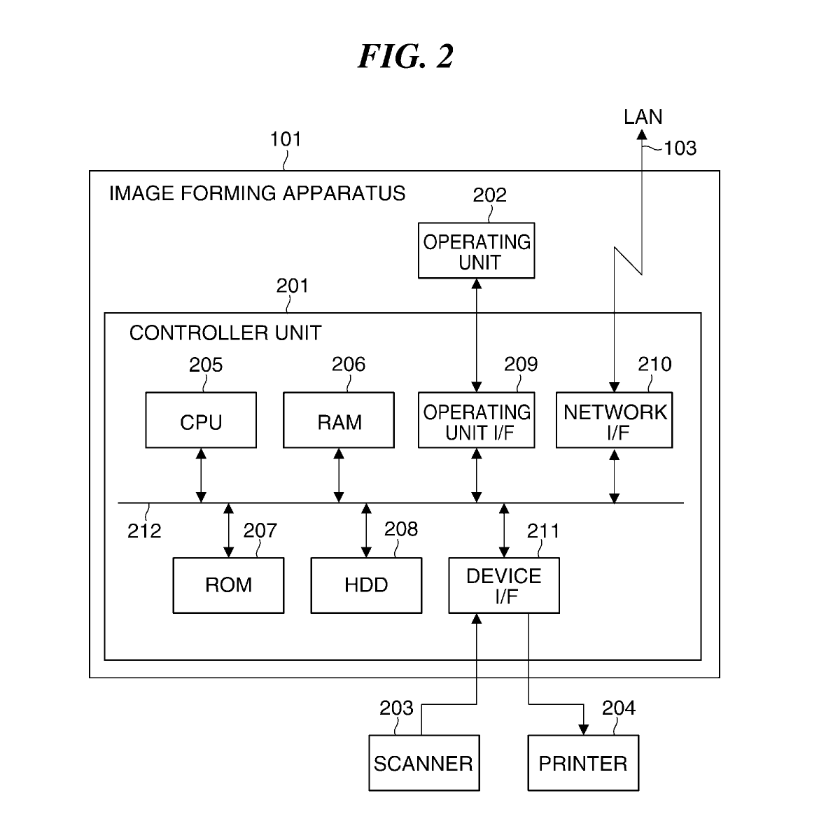

FIG. 2 is a block diagram schematically showing an internal arrangement of the image forming apparatus 101 in FIG. 1.

The image forming apparatus 101 in FIG. 2 has a controller unit 201, an operating unit 202, a scanner 203, and a printer 204. The controller unit 201 has a CPU 205, a RAM 206, a ROM 207, an HDD 208, an operating unit I/F 209, a network I/F 210, and a device I/F 211, and these component elements are connected to one another via a system bus 212. The operating unit I/F 209 connects the controller unit 201 and the operating unit 202 together, the network unit I/F 210 connects the controller unit 201 and the LAN 103 together, and the device I/F 211 connects the controller unit 201 and the scanner 203 and the printer 204 together.

The operating unit 202 has hardware keys, an operating panel, and so on, and a user inputs instructions to the image forming apparatus 101 through the hardware keys and the operating panel. It should be noted that the operating panel may have, for example, a liquid crystal monitor, and for example, information on the image forming apparatus 101 is displayed on the liquid crystal monitor. The scanner 203 reads a recording sheet on which characters or the like are written and generates image data. The generated image data is stored in, for example, the HDD 208. The printer 204 prints, for example, image data stored in the HDD 208.

The CPU 205 controls the component elements of the image forming apparatus 101. The RAM 206 is a system work memory for the CPU 205 and stores programs and various data such as image data, an operating system, system software, and application software. The ROM 207 stores a boot program for the image forming apparatus 101. The HDD 208 stores an operating system, system software, application software, image data, setting data, and so forth.

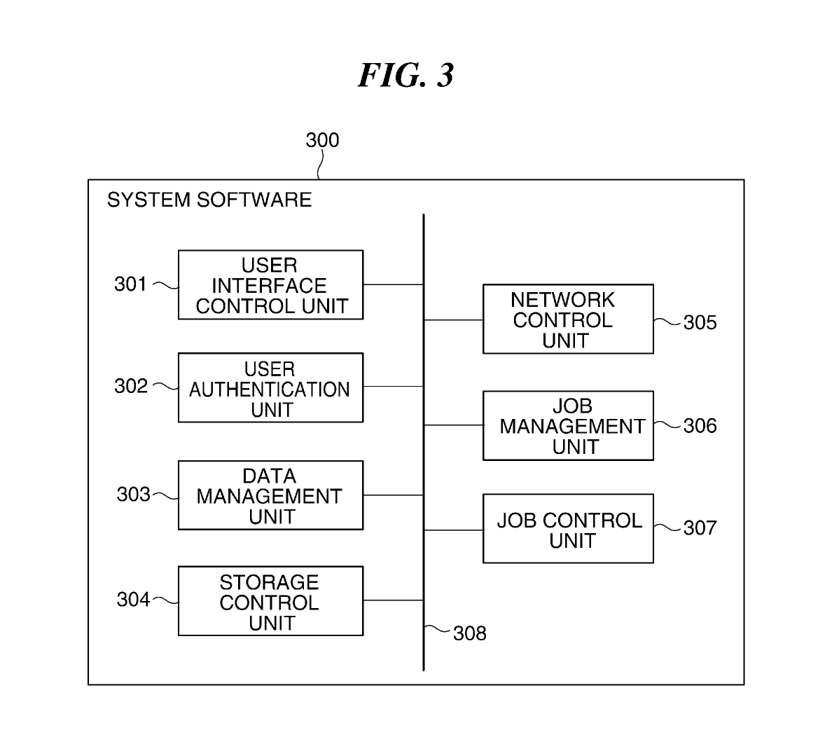

FIG. 3 is a block diagram schematically showing an internal arrangement of system software 300 of the image forming apparatus 101, which is executed by the CPU 205 of the image forming apparatus 101 in FIG. 2.

The system software 300 in FIG. 3 has a user interface control unit 301, a user authentication unit 302, a data management unit 303, a storage control unit 304, a network control unit 305, a job management unit 306, and a job control unit 307, and these component elements are connected to one another via a bus 308.

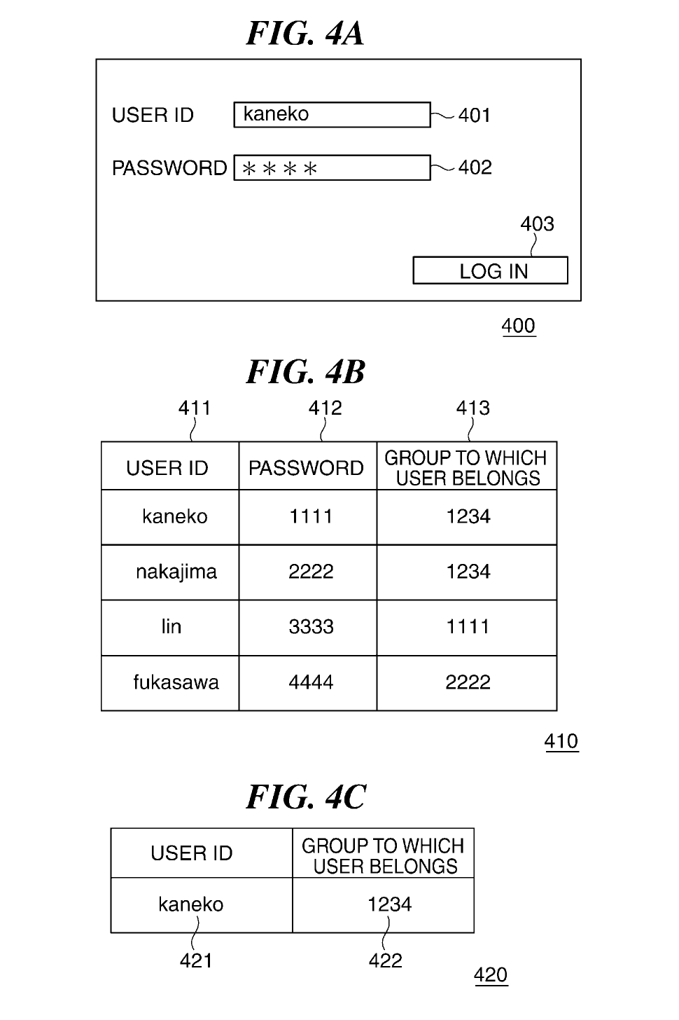

The user interface control unit 301 receives information input by a user via the operating unit 202 and sends the received information to the data management unit 303 and the job management unit 306. The user interface control unit 301 also displays, on the operating unit 202, information received from the data management unit 303 and the job management unit 306. The user authentication unit 302 performs user authentication based on input information input by a user on a user authentication screen 400 (FIG. 4A), to be described later, and authentication information stored in a database 410 (FIG. 4B), to be described later.

The user authentication screen in FIG. 4A has entry fields 401 and 402 and a login button 403. A user ID is entered into the entry field 401, and a password is entered into the entry field 402. A user depresses the login button 403 after confirming that the user ID and password entered into the entry fields 401 and 402 are correct. When the login button 403 is depressed, the user ID and the password entered into the entry fields 401 and 402 are compared with a user ID and a password which are authentication information stored in the database 410, to be described later. When the user ID and password entered into the entry fields 401 and 402 match the user ID and the password, respectively, in the database 410, the user authentication unit 302 authenticates the user and generates a login context 420 (FIG. 4C), to be described later, in the storage control unit 304.

The database 410 in FIG. 4B is stored in the HDD 208 and has user IDs 411, passwords 412, and groups 413. The user IDs 411 and the passwords 412 are required when users are authenticated, and the groups 413 are those to which users belong when the users are group users.

The login context 420 in FIG. 4C shows information on a user authenticated by the image forming apparatus 101. The login context 420 has a user ID 421 and a group 422 to which a user belongs. The user ID 421 is a user ID of a user authenticated by the user authentication unit 302, and the group 422 is a group to which a user authenticated by the user authentication unit 302 belongs when the user is a group user. It should be noted that when a user authenticated by the user authentication unit 302 is a private user, not a group user, a user ID is indicated as the user ID 421, but nothing is indicated as the group 422.

Referring again to FIG. 3, the data management unit 303 receives a request relating to writing of data or readout of data from the user interface control unit 301, the network control unit 305, or the job management unit 306 and sends this request to the storage control unit 304. The data management unit 303 also receives a response to this request from the storage control unit 304 and sends this response to the user interface control unit 301, the network control unit 305, or the job management unit 306.

The storage control unit 304 receives a request relating to writing of data or readout of data from the data management unit 303, and for example, writes data into the HDD 208 or reads out data from the HDD 208. The storage control unit 304 then notifies the data management unit 303 of whether or not the writing or readout is successful. The network control unit 304 also manages the database 410 stored in the HDD 208. The network control unit 305 receives requests relating to various processes from the PC 102 and sends the requests to the data management unit 303 and the job management unit 306. The network control unit 305 also receives responses to the requests from the data management unit 303 and the job management unit 306 and sends the responses to the PC 102.

The job management unit 306 receives, for example, job execution requests from the user interface control unit 301 and the network control unit 305 and manages received jobs. The job management unit 306 also requests the job control unit 307 to execute the received jobs. The job control unit 307 receives requests relating to job execution from the job management unit 306 and controls operation of the scanner 203 and the printer 204. The job control unit 307 also receives information on operating statuses of the scanner 203 and the printer 204 and sends the information on the operating statuses to the job management unit 306.

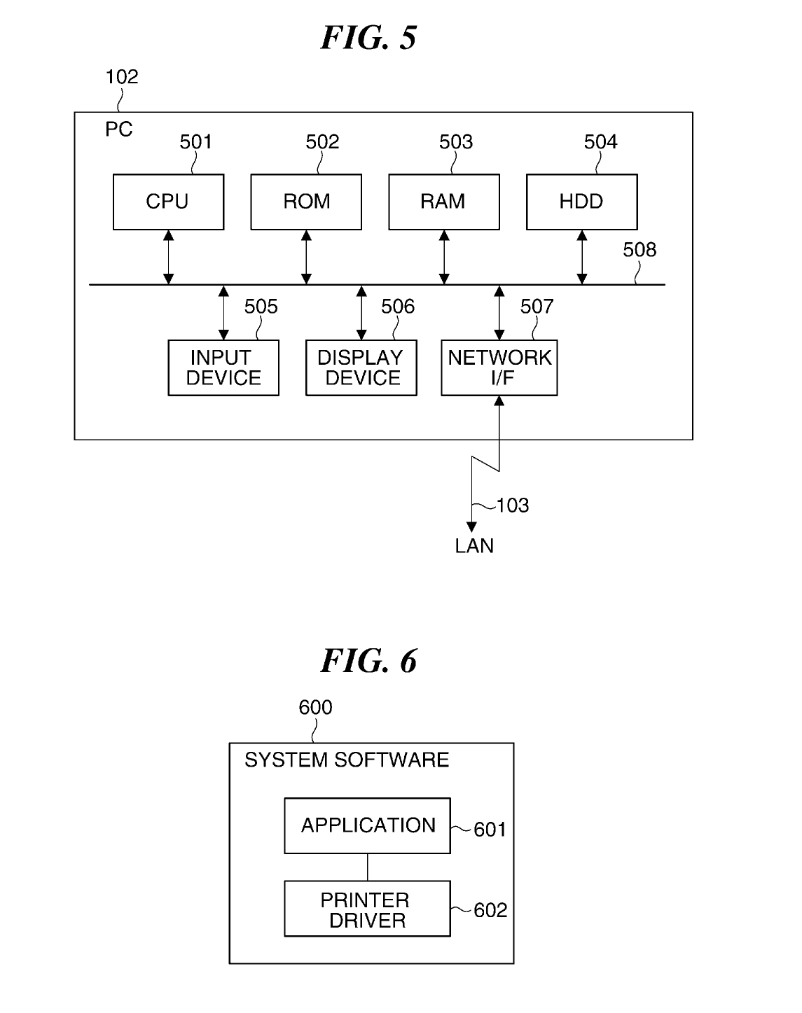

FIG. 5 is a block diagram schematically showing an internal arrangement of the PC 102 in FIG. 1.

The PC 102 in FIG. 5 has a CPU 501, a ROM 502, a RAM 503, an HDD 504, an input device 505, a display device 506, and a network I/F 507, and these component elements are connected to one another via a system bus 508. The network I/F 507 connects the PC 102 and the LAN 103 together.

The CPU 501 is a computation device which controls the overall system of the PC 102. The ROM 502 stores programs and data. The RAM 503 is a system work memory for the CPU 501 and stores, for example, image data. The HDD 504 stores programs, image data, application data, and so forth. The input device 505 is, for example, a keyboard or a pointing device and used for a user to input instructions to the PC 102. The display device 506 displays an operating condition of the PC 102 and information on programs running on the PC 102.

FIG. 6 is a block diagram schematically showing an arrangement of system software 600 of the PC 102, which is executed by the CPU 501 of the PC 102 in FIG. 5.

The system software 600 has an application 601 and a printer driver 602, which is connected to the application 601. The application 601 is, for example, software which creates or edits image data and document data. For example, a user creates document data using the application 601 and sends the created document data as a print job to the image forming apparatus 101 via the printer driver 602. The printer driver 602 allows designation of the number of print copies and designation of monochrome/color printing.

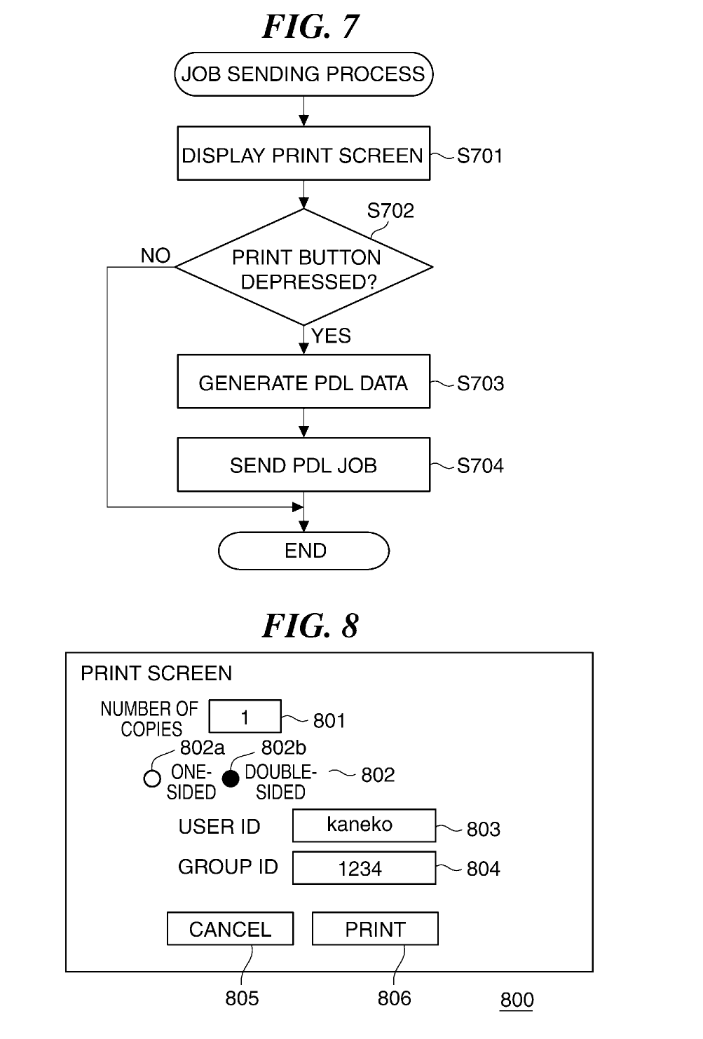

FIG. 7 is a flowchart showing the procedure of a job sending process which is carried out by the printer driver 602 in FIG. 6. The job sending process in FIG. 7 is carried out when the printer driver 602 sends a print job from the PC 102 to the image forming apparatus 101.

Referring to FIG. 7, first, the printer driver 602 displays a print screen 800 (FIG. 8), to be described later, on the display device 506 of the PC 102 (step S701). The print screen 800 in FIG. 8 has an entry field 801, a selection button 802, a user ID entry field 803, a group ID entry field 804, a cancel button 805, and a print button 806. The selection button 802 has radio buttons 802a and 802b.

The number of print copies is entered into the entry field 801. The radio buttons 802a and 802b which the selection button 802 has is selected to set information on a printing side. Specifically, the radio button 802a is selected to perform printing of print data on one side of a recording sheet, and the radio button 802b is selected to perform printing of print data on both sides of a recording sheet. An ID of a user who sends a print job from the PC 102 to the image forming apparatus 101 is entered into the user ID entry field 803. An ID of a group to which a user who sends a print job from the PC 102 to the image forming apparatus 101 belongs is entered into the group ID entry field 804 when the user is a group user. The cancel button 805 is depressed to cancel transmission of a print job from the PC 102 to the image forming apparatus 101, and the print button 806 is depressed to perform transmission of a print job from the PC 102 to the image forming apparatus 101.

Referring again to FIG. 7, the printer driver 602 determines whether or not the print button 806 has been depressed (step S702). As a result of the determination in the step S702, when the print button 806 has been depressed, the printer driver 602 generates, for example, a PDL (page description language) job (step S703), sends the PDL job to the image forming apparatus 101 (step S704), and terminates the present process. On the other hand, when the print button 806 has not been depressed, the printer driver 602 skips the steps S703 and S704 and terminates the present process.

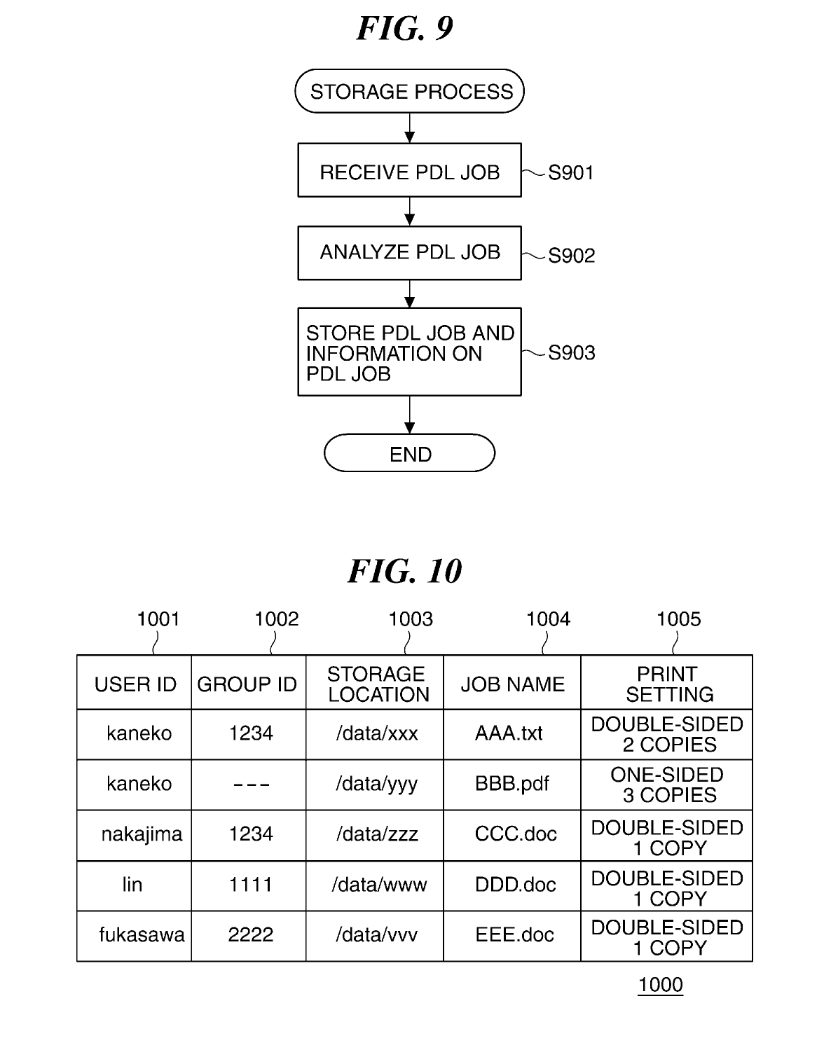

FIG. 9 is a flowchart showing the procedure of a storage process in which the PDL job sent to the image forming apparatus 101 in the step S704 in FIG. 7 is stored in a storage device which the image forming apparatus 101 has.

Referring to FIG. 9, first, the network control unit 305 receives the PDL job from the PC 102 and sends the PDL job to the job management unit 306 (step S901). The job management unit 306 receives the PDL job and sends the received PDL job to the data management unit 303, which in turn analyzes the received PDL job to obtain information on the PDL job (step S902). The data management unit 303 then sends the PDL job and the information on the PDL job to the storage control unit 304, which in turn stores (accumulates) the PDL job and the information on the PDL job in a storage device which the image forming apparatus 101 has, for example, the HDD 208 (step S903) and terminates the present process.

FIG. 10 is a view useful in explaining an information list 1000 showing the information on the PDL job stored in the storage device in the step S903 in FIG. 9.

The information list 1000 in FIG. 10 includes user IDs 1001, group IDs 1002, storage locations 1003, print job names 1004, and print settings 1005. The user IDs 1001 are user IDs entered into the user ID entry field 803, and the group IDs 1002 are group IDs entered into the group ID entry field 804. The storage locations 1003 are locations at which PDL jobs are stored, the print job names 1004 are names of PDL jobs stored at the storage locations 1003, and the print settings 1005 are information on the number of print copies entered into the entry field 801 and single-sided printing/double-sided printing selected by the selection button 802.

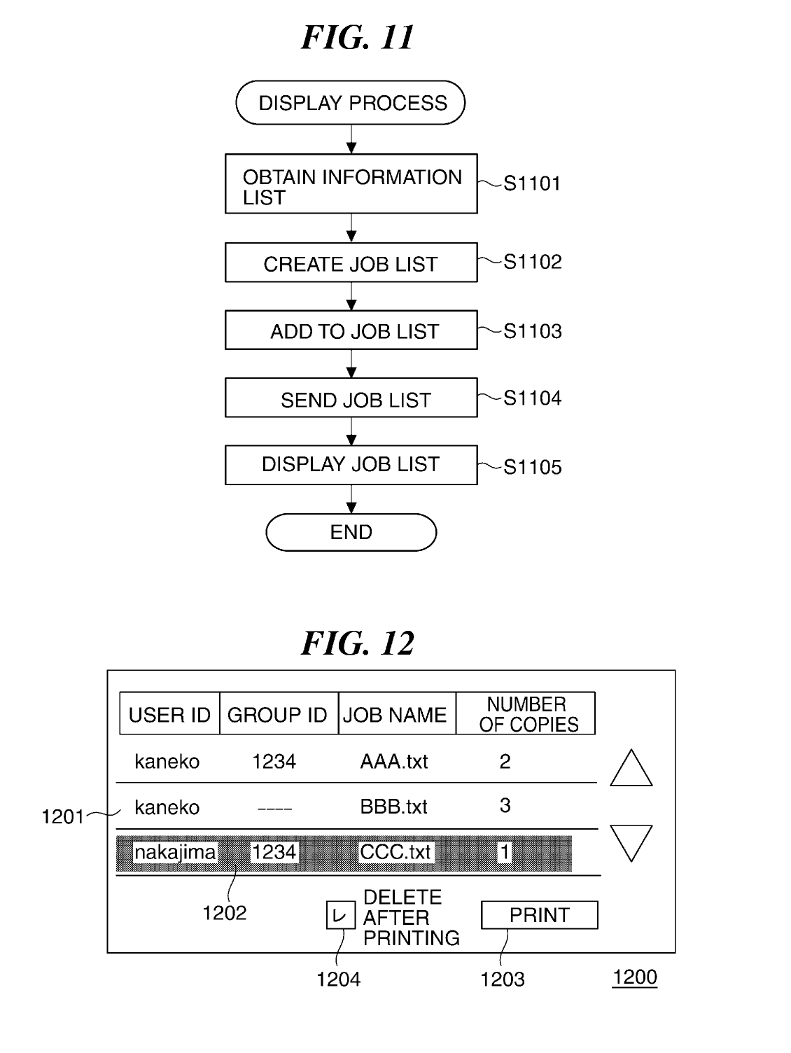

FIG. 11 is a flowchart showing the procedure of a display process in which a job list generated based on the information list 1000 in FIG. 10 is displayed on the operating unit 202. The display process in FIG. 11 is carried out by the job management unit 306.

Referring to FIG. 11, first, the job management unit 306 obtains the information list 1000 (step S1101) and extracts a PDL job for which the user IDs 1001 in the information list 1000 match the user ID 421 in the login context 420 and generates a job list including the extracted PDL jobs (step S1102). Next, the job management unit 306 extracts PDL jobs (except for the PDL jobs already extracted in the step S1102) for which the group IDs 1002 in the information list 1000 match the group 422 in the login context 420 and adds the extracted PDL jobs to the job list (step S1103) and then sends the job list to the user interface control unit 301 (step S1104). The user interface control unit 301 displays the received job list on the operating unit 202 (step S1105) and terminates the present process.

FIG. 12 is a view useful in explaining a job list 1200 which is displayed on the operating unit 202 in the step S1105 in FIG. 11.

The job list 1200 in FIG. 12 has a display area 1201, a print button 1203, and a checkbox 1204.

A PDL job 1202 displayed in the display area 1201 is a selected PDL job, which is to be executed when the print button 1203 is depressed. The checkbox 1204 is marked based on a user's intention. When the checkbox 1204 is marked, the deleting function described above is enabled, and a PDL job is deleted from the storage location 1003 in the information list 1000 immediately after the PDL job is executed. On the other hand, when the checkbox 1204 is not marked, the deleting function is not enabled, and an executed PDL job continues to be stored in the storage location 1003 in the information list 1000.

In the above described cases, the deleting function is enabled by marking the checkbox 1204, but the deleting function may be enabled using another method, for example, by depressing an enabling button, which is provided to enable the deleting function. In this case, the enabling button may be either a software key or a hardware key.

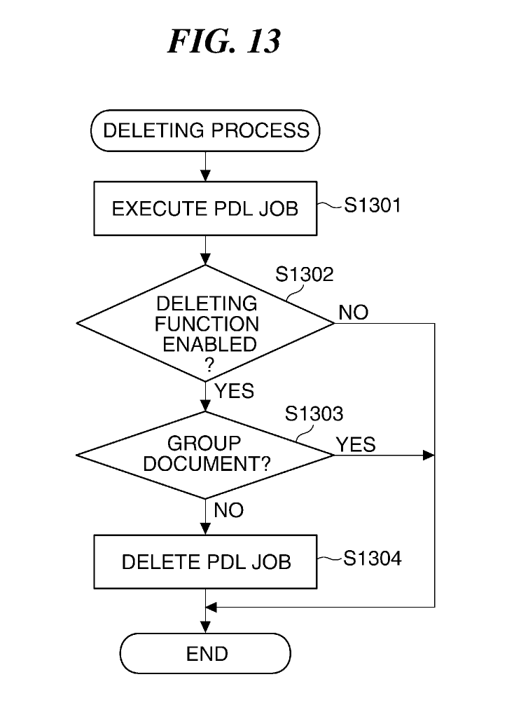

FIG. 13 is a flowchart showing the procedure of a deleting process in which the PDL job 1202 selected in the display area 1201 in FIG. 12 is deleted after being executed. The deleting process in FIG. 13 is carried out by the job management unit 306.

Referring to FIG. 13, first, the job management unit 306 executes the PDL job 1202 (step S1301) and then based on the checkbox 1204, determines whether or not the deleting function is enabled (step S1302).

As a result of the determination in the step S1302, when the deleting function is enabled, the job management unit 306 determines whether or not the executed PDL job 1202 is a group document (step S1303). Here, a group document means a PDL job that is sent to the image forming apparatus 101 by a group user, and execution of this PDL job can be ordered by not only this group user but also the other group users. It should be noted that a group document may be merely a PDL job that is shared by this group user concerned and the other group users. Whether or not the executed PDL job 1202 is a group document is determined based on the group ID 1002 in the information list 1000. As a result of the determination in the step S1303, when the executed PDL job 1202 is not a group document, the job management unit 306 deletes the PDL job 1202 from the storage location 1003 (step S1304) and terminates the present process.

As a result of the determination in the step S1302, when the deleting function is not enabled, the job management unit 306 skips the steps S1303 and S1304 and terminates the present process without deleting the PDL job 1202 from the storage location 1003. As a result of the determination in the step S1303, when the executed PDL job 1202 is a group document, the job management unit 306 skips the step S1304 and terminates the present process.

According to the process in FIG. 13, when the executed PDL job 1202 is a group document (YES in the step S1303), the PDL job 1202 corresponding to the group document is not deleted from the storage location 1003, and hence even when a group user who shares the group document with other group users orders execution of the PDL job 1202 corresponding to the group document, the PDL job 1202 is not deleted. As a result, all the group users who share the group document are allowed to order execution of the PDL job 1202 corresponding to the group document. Moreover, whether or not the executed PDL job 1202 is a group document is easily determined because the determination is made based on the group ID 1002 in the information list 1000 (step S1303).

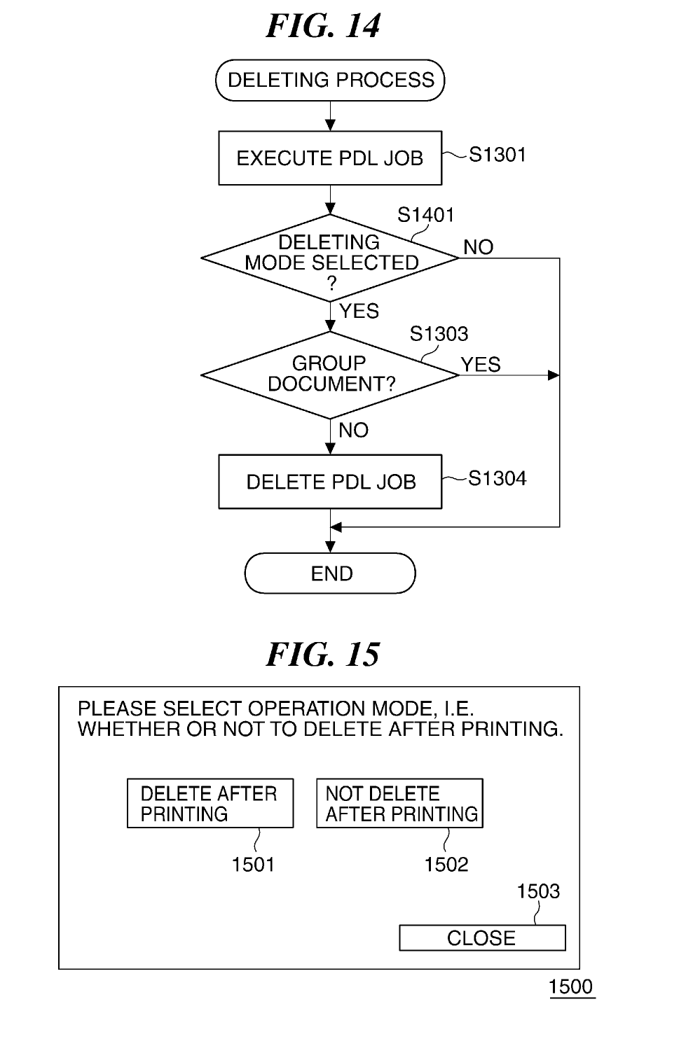

FIG. 14 is a flowchart showing a first variation of the deleting process in FIG. 13. Processes in steps S1301, S1303, and S1304 in FIG. 14 are the same as those in the steps S1301, S1303, and S1304 in FIG. 13, and therefore, only features different from the process in FIG. 13 will be described below.

Referring to FIG. 14, the job management unit 306 executes the PDL job 1202 (step S1301) and determines whether or not the image forming apparatus 1001 is placed in a deleting mode (step S1401). Here, the deleting mode is a mode in which the PDL job 1202 is deleted from the storage location 1003 immediately after it is executed. The deleting mode is selected via a mode setting screen 1500 in FIG. 15, to be described later.

The mode setting screen 1500 in FIG. 15 has a deleting mode selecting button 1501, a deselecting button 1502, and a button 1503. When the deleting mode selecting button 1501 is selected, and the button 1503 is depressed, the image forming apparatus 1001 is placed in the deleting mode. When the deselecting button 1502 is selected, and the button 1503 is depressed, the image forming apparatus 1001 is not placed in the deleting mode.

Referring again to FIG. 14, when the job management unit 306 determines in the step S1401 that the deleting mode is selected, the process proceeds to the step S1303, and when the deleting mode is not selected, the job management unit 306 skips the steps S1303 and S1304 and terminates the present process.

According to the process in FIG. 14, even when the image forming apparatus 1001 is placed in the deleting mode in which the PDL job 1202 is deleted from the storage location 1003 immediately after being executed (YES in the step S1401), the PDL job 1202 is not deleted when the executed PDL job 1202 is a group document (Yes in the step S1303). Namely, when it is determined that the executed PDL job 1202 is shared by a plurality of users, the PDL job 1202 corresponding to the group document is not deleted even if the deleting mode is selected, and this prevents the PDL job 1202 corresponding to the group document of which execution can be ordered by other group users from being deleted. It should be noted that whether to delete a PDL job after it is executed can be set for a private document and a group document, respectively, using the mode setting screen 1500 in FIG. 15. In this case, when it is determined in the process in FIG. 14 that a PDL job is a group document (Yes in the S1303), whether to delete the PCL 1202 is decided according to a deleting mode set for the group document, and when it is determined in the process in FIG. 14 that a PDL job is a private document (No in the S1303), whether to delete the PL job is decided according to a deleting mode set for the private document.

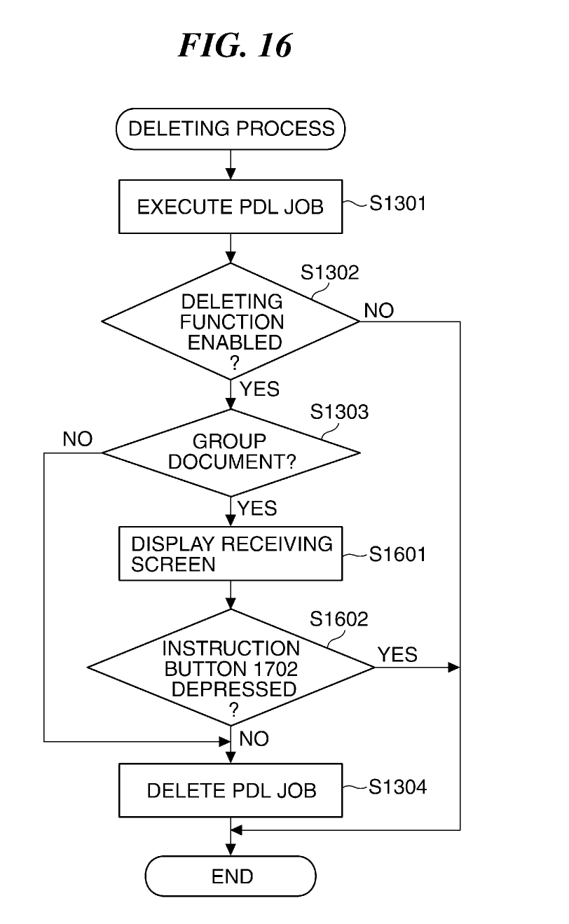

FIG. 16 is a flowchart showing a second variation of the deleting process in FIG. 13. Processes in steps S1301 to S1304 in FIG. 16 are the same as those in the steps S1301 to S1304 in FIG. 13, and therefore, only features different from the process in FIG. 13 will be described below.

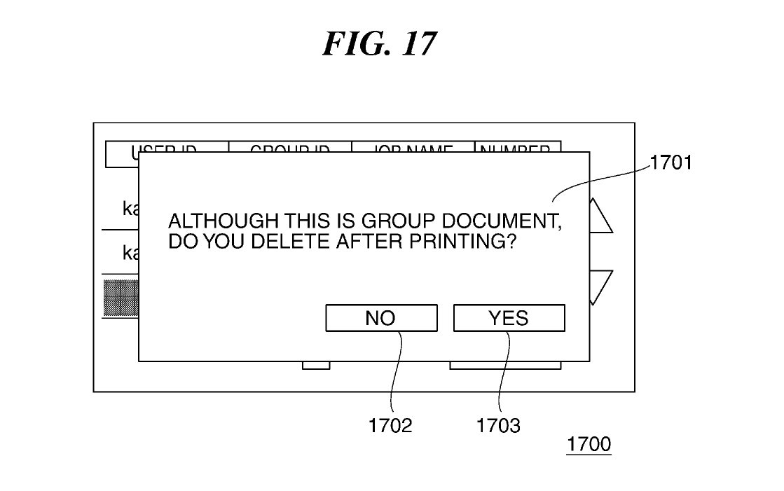

Referring to FIG. 16, as a result of the determination in the step S1303, when the executed PDL job 1202 is a group document, the job management unit 306 displays a receiving screen 1700 (FIG. 17), to be described later, on the operating unit 202 (step S1601).

The receiving screen 1700 in FIG. 17 has a confirmation display 1701 and instruction buttons 1702 and 1703. The confirmation display 1701 shows that the executed PDL job 1202 is a group document and asks a user whether or not to delete the PDL job 1202 after it is executed. The instruction button 1702 is depressed when the PDL job 1202 is not to be deleted, and the instruction button 1703 is depressed when the PDL job 1202 is to be deleted.

Referring again to FIG. 16, the job management unit 306 determines whether or not the instruction button 1702 on the receiving screen 1700 has been depressed (step S1602). As a result of the determination in the step S1602, when the instruction button 1702 has been depressed, the job management unit 306 skips the step S1304 and terminates the present process. On the other hand, when the job management unit 306 determines that the instruction button 1702 has not been depressed (when the instruction button 1703 has been depressed), the process proceeds to the step S1304. It should be noted that when the job management unit 306 determines in the step S1303 that the executed PDL job 1202 is not a group document, the process proceeds to the step S1304 with the steps S1601 and S1602 skipped.

According to the process in FIG. 16, when the executed PDL job 1202 is a group document (YES in the step S1303), and the instruction button 1702 has been depressed (YES in the step S1602), the PDL job 1202 is not deleted. On the other hand, when the executed PDL job 1202 is a group document (YES in the step S1303), and the instruction button 1703 has been depressed (NO in the step S1602), the PDL job 1202 is deleted. Namely, when the executed PDL job 1202 is a group document, whether or not to delete the PDL job 1202 is determined based on a received instruction, and therefore, an intention of the user is reliably reflected on whether or not to delete the PDL job 1202 corresponding to the group document.

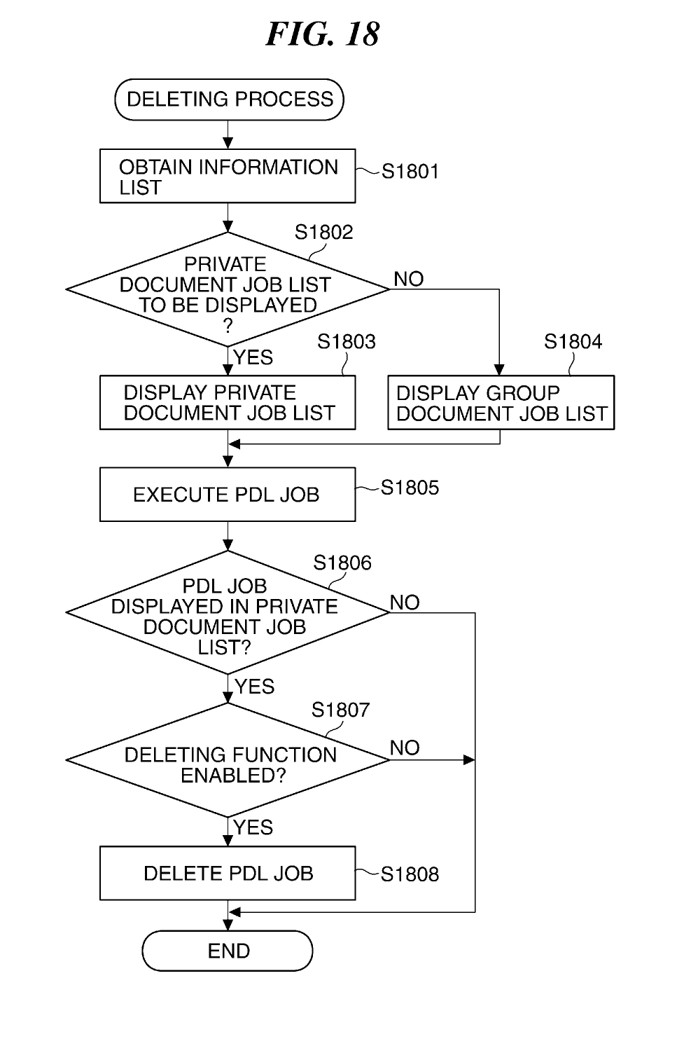

FIG. 18 is a flowchart showing a third variation of the deleting process in FIG. 13.

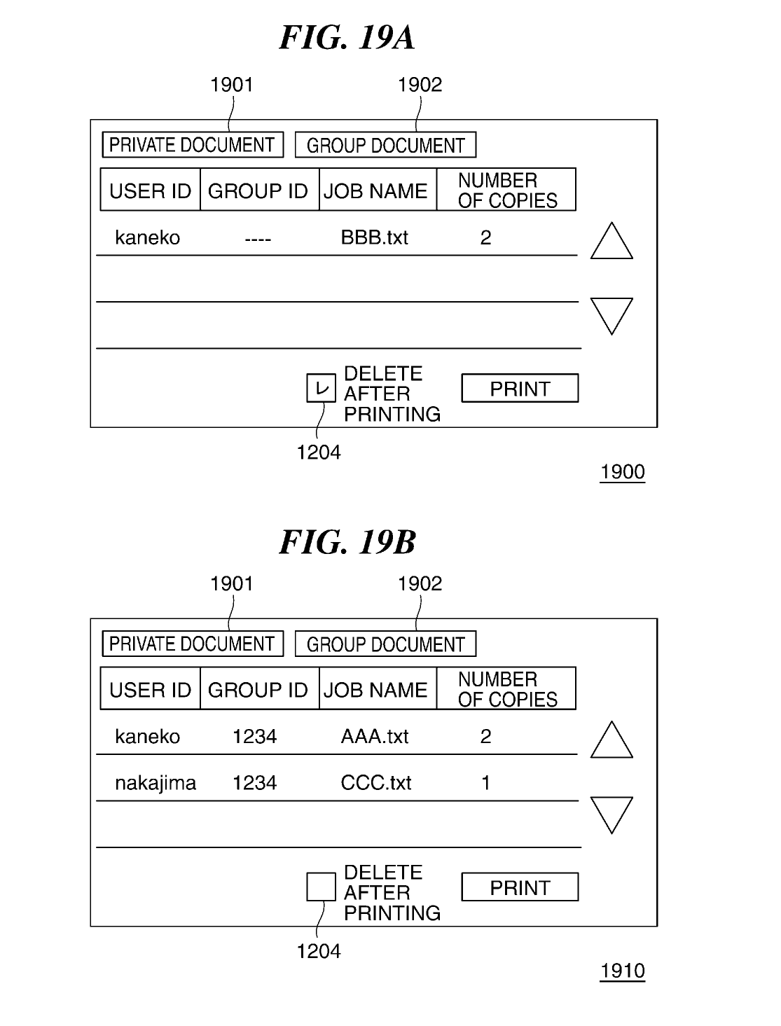

Referring to FIG. 18, first, the job management unit 306 obtains the information list 1000 (step S1801) and determines whether or not displaying of a private document job list 1900 (FIG. 19A), to be described later, or a group document job list 1910 (FIG. 19B, to be described later, on the operating unit 202 is requested (step S1802).

FIGS. 19A and 19B are views useful in explaining the private document job list 1900 and the group document job list 1910 displayed in step S1803 or S1804 in FIG. 18.

Configurations of the private document job list 1900 and the group document job list 1910 are basically the same as the configuration of the job list 1200, and the private document job list 1900 and the group document job list 1910 differ from the job list 1200 in that they have selection buttons 1901 and 1902 for a user to select the private document job list 1900 or the group document job list 1910 as a job list to be displayed on the operating unit 202.

The private document job list 1900, which is comprised of PDL jobs sent to the image forming apparatus 101 by a private user, is displayed on the operating unit 202 when the selection button 1901 is depressed. The group document job list 1910, which is comprised of PDL jobs sent to the image forming apparatus 101 by group users, is displayed on the operating unit 202 when the selection button 1902 is depressed.

The checkbox 1204 of the private document job list 1900 is marked based on a user's intention. When the checkbox 1204 is marked, the deleting function is enabled, and executed PDL jobs are deleted immediately after they are executed. On the other hand, when the checkbox 1204 is not marked, the deleting function is not enabled, and executed PDL jobs continue to be stored in the storage locations 1003 without being deleted.

On the other hand, the checkbox 1204 of the group document job list 1910 is not allowed to be marked (the checkbox 1204 is disabled). Thus, PDL jobs displayed in the group document job list 1910 continue to be stored in the storage locations 1003 without being deleted.

The private document job list 1900 is comprised of PDL jobs for which the user IDs 1001 in the information list 1000 match the user ID 421 in the login context 420 and which have no group IDs. The group document job list 1910 is comprised of PDL jobs for which the user IDs 1001 in the information list 1000 match the user ID 421 in the login context 420, and also the group IDs 1002 in the information list 1000 match the group 422 in the login context 420.

Referring again to FIG. 18, as a result of the determination in the step S1802, when displaying of the private document job list 1900 is requested, the job management unit 306 generates the private document job list 1900 and displays the same on the operating unit 202 (step S1803), and when displaying of the group document job list 1910 is requested, the job management unit 306 generates the group document job list 1910 and displays the same on the operating unit 202 (step S1804).

The job management unit 306 then executes a PDL job selected by the user from the private document job list 1900 or the group document job list 1910 displayed on the operating unit 202 (step S1805) and determines whether or not the executed PDL job is included in the private document job list 1900 (step S1806). As a result of the determination in the step S1806, when the executed PDL job is included in the private document job list 1900, the job management unit 306 determines based on the checkbox 1204 whether or not the deleting function is enabled (step S1807). As a result of the determination in the step S1807, when the deleting function is enabled, the job management unit 306 executes the PDL job and then deletes the PDL job from the storage location 1003 (step S1803) and terminates the present process. On the other hand, as a result of the determination in the step S1807, when the deleting function is not enabled, the job management unit 306 skips the step S1808 and terminates the present process without deleting the PDL job from the storage location 1003.

As a result of the determination in the step S1806, when the executed PDL job is not included in the private document job list 1900 (the executed PDL job is included in the group document job list 1910), the checkbox 1204 is disabled, and the job management unit 306 skips the steps S1807 and S1808 and terminates the present process without deleting the PDL job.

According to the process in FIG. 18, when the group document job list 1910 is generated (step S1804), and an executed PDL job is included in the group document job list 1910, the checkbox 1204 is disabled, and the PDL job is not deleted (NO in the step S1806). This prevents the user from involuntarily deleting a PDL job included in the group document job list 1910.

Moreover, when an executed PDL job is included in the private document job list 1900 (YES in the step S1806), and the deleting function is enabled (YES in the step S1807), the PDL job is deleted from the storage location 1003 after being executed (step S1808). As a result, a PDL job of which execution is never ordered by other users is immediately deleted from the storage location 1003, and this prevents the PDL job from continuing to be stored in the storage location 1003.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-191491, filed Sep. 19, 2014, which is hereby incorporated by reference herein in its entirety.

What is claimed is:

1. An image forming apparatus for which execution of a stored print job is ordered by a user, comprising:
a deleting unit configured to delete the print job after the print job is executed;
a determination unit configured to determine whether execution of the print job is ordered by a plurality of users; and
a decision unit configured to decide whether to enable or disable said deleting unit based on a determination result by said determination unit.

2. The image forming apparatus according to claim 1, further comprising a mode setting unit configured to select a deleting mode in which the print job is deleted after the print job is executed,
wherein even in a case where the deleting mode is selected, said deleting unit does not delete the print job when it is determined that execution of the print job is ordered by a plurality of users.

3. The image forming apparatus according to claim 1, further comprising a receiving unit configured to, when it is determined that execution of the print job is ordered by a plurality of users, receive an instruction as to whether to delete the print job,
wherein said deleting unit does not delete the print job when said receiving unit receives an instruction not to delete the print job, and said deleting unit deletes the print job when said receiving unit receives an instruction to delete the print job.

4. The image forming apparatus according to claim 1, further comprising a generation unit configured to generate a job list including at least one print job for which it has been determined that execution thereof is ordered by a plurality of users,
wherein said generation unit makes such a setting that the print job included in the job list is not to be deleted.

5. The image forming apparatus according to claim 1, wherein when it is determined that execution of the print job is not ordered by a plurality of users, said deleting unit deletes the print job after the print job is executed.

6. The image forming apparatus according to claim 1, wherein a group ID that is information on the print job is set for the print job for which it has been determined that execution thereof is ordered by a plurality of users.

7. A control method for an image forming apparatus for which execution of a stored print job is ordered by a user, comprising:
a deleting step of deleting the print job after the print job is executed;
a determination step of determining whether execution of the print job is ordered by a plurality of users; and
a decision step of deciding whether to delete the print job in said deleting step based on a determination result in said determination step.

8. A non-transitory computer-readable storage medium storing a program for causing a computer to execute a control method for an image forming apparatus for which execution of a stored print job is ordered by a user, the control method comprising:
a deleting step of deleting the print job after the print job is executed;
a determination step of determining whether execution of the print job is ordered by a plurality of users; and
a decision step of deciding whether to delete the print job in said deleting step based on a determination result in said determination step.
